(19) United States
(12) Patent Application Publication
(10) Pub. No.: US 2015/0194654 A1
(43) Pub. Date: Jul. 9, 2015

(54) THERMALLY CURABLE COMPOSITE SEPARATORS FOR BATTERIES IN PORTABLE ELECTRONIC DEVICES

(71) Applicant: Apple Inc., Cupertino, CA (US)

(72) Inventors: Bookeun Oh, Fremont, CA (US); Sang Young Yoon, San Jose, CA (US); Richard M. Mank, Los Altos, CA (US)

(73) Assignee: Apple Inc., Cupertino, CA (US)

(21) Appl. No.: 14/148,033

(22) Filed: Jan. 6, 2014

(51) Int. Cl. H01M 2/16; H01M 2/14; G06F 1/16; H01M 10/04

(52) U.S. Cl. CPC H01M 2/1686; H01M 2/168; H01M 10/049; H01M 2/145; G06F 1/1635; H01M 2220/30

(57) ABSTRACT

The disclosed embodiments relate to the design and manufacture of a battery cell. The battery cell contains a set of layers, including a cathode with an active coating, an anode with an active coating, and a composite separator containing an adhesion polymer layer that does not reflow after a thermal treatment of the battery cell is performed to laminate the layers together. The battery cell also includes a pouch enclosing the layers, wherein the pouch is flexible.

### BACKGROUND

1. Field

The disclosed embodiments relate to batteries for portable electronic devices. More specifically, the disclosed embodiments relate to the design and manufacture of batteries for portable electronic devices with thermally curable composite separators.

2. Related Art

Rechargeable batteries are presently used to provide power to a wide variety of portable electronic devices, including laptop computers, tablet computers, mobile phones, personal digital assistants (PDAs), digital music players and cordless power tools. The most commonly used type of rechargeable battery is a lithium battery, which can include a lithium-ion or a lithium-polymer battery.

Lithium-polymer batteries often include cells that are packaged in flexible pouches. Such pouches are typically lightweight and inexpensive to manufacture. Moreover, these pouches may be tailored to various cell dimensions, allowing lithium-polymer batteries to be used in space-constrained portable electronic devices such as mobile phones, laptop computers, and/or digital cameras. For example, a lithium-polymer battery cell may achieve a packaging efficiency of 90-95% by enclosing rolled electrodes and electrolyte in an aluminized laminated pouch. Multiple pouches may then be placed side-by-side within a portable electronic device and electrically coupled in series and/or in parallel to form a battery for the portable electronic device.

During operation, a lithium-polymer battery's capacity may diminish over time from an increase in internal impedance, electrode and/or electrolyte degradation, excessive heat, and/or abnormal use. For example, oxidation of electrolyte and/or degradation of cathode and anode material within a battery may be caused by repeated charge-discharge cycles and/or age, which in turn may cause a gradual reduction in the battery's capacity. As the battery continues to age and degrade, the capacity's rate of reduction may increase, particularly if the battery is continuously charged at a high charge voltage and/or operated at a high temperature.

Continued use of a lithium-polymer battery over time may also produce swelling in the battery's non-rigid cells and eventually cause the battery to exceed the designated maximum physical dimensions of the portable electronic device. Such swelling may be caused by reflowing of adhesion polymer layers between the electrodes during exposure to heat, which produces degradation in the interfaces between the layers of the battery. The degraded interfaces may increase the thickness of the battery and result in lithium plating, which may produce gas and/or result in additional swelling in the battery. Moreover, conventional battery-monitoring mechanisms may not include functionality to manage swelling of the battery. As a result, a user of the device may not be aware of the battery's swelling and/or degradation until the swelling results in physical damage to the device.

Hence, what is needed is a mechanism for mitigating swelling in batteries for portable electronic devices.

### SUMMARY

The disclosed embodiments relate to the design and manufacture of a battery cell. The battery cell contains a set of layers, including a cathode with an active coating, an anode with an active coating, and a composite separator containing an adhesion polymer layer that does not reflow after a thermal treatment of the battery cell is performed to laminate the layers together. The battery cell also includes a pouch enclosing the layers, wherein the pouch is flexible.

In some embodiments, the composite separator also includes a microporous separator and an inorganic filler layer disposed between the microporous separator layer and the adhesion polymer layer.

In some embodiments, the inorganic filler layer includes a ceramic coating.

In some embodiments, the inorganic filler layer is disposed on one or both sides of the microporous separator.

In some embodiments, the adhesion polymer layer includes a base polymer and a precursor compound that cures during the thermal treatment of the battery cell.

In some embodiments, the adhesion polymer layer includes the precursor compound in the range of 3-25% by weight.

In some embodiments, the adhesion polymer layer further includes an activator compound for the precursor compound.

In some embodiments, the adhesion polymer layer includes the activator compound in the range of 0.1-0.5% by weight.

In some embodiments, the layers are wound to create a jelly roll or stacked prior to sealing the layers in the pouch.

### BRIEF DESCRIPTION OF THE FIGURES

FIG. 1 shows the placement of a battery in a computer system in accordance with the disclosed embodiments.

FIG. 2 shows a battery cell in accordance with the disclosed embodiments.

FIG. 3 shows a set of layers for a battery cell in accordance with the disclosed embodiments.

FIG. 4 shows a set of layers for a battery cell in accordance with the disclosed embodiments.

FIG. 5 shows an adhesion polymer layer of a composite separator in a battery cell in accordance with the disclosed embodiments.

FIG. 6 shows a flowchart illustrating the process of manufacturing a battery cell in accordance with the disclosed embodiments.

FIG. 7 shows a flowchart illustrating the process of manufacturing a composite separator for a battery cell in accordance with the disclosed embodiments.

FIG. 8 shows a portable electronic device in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

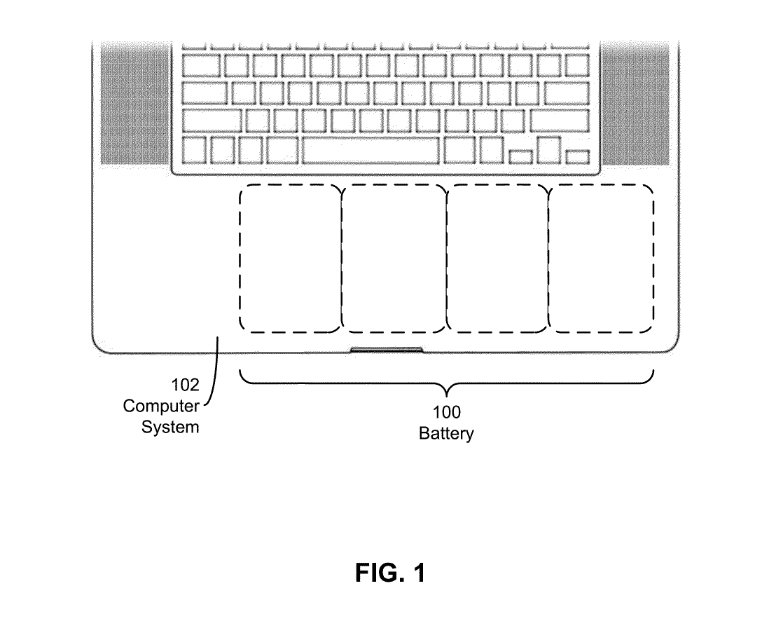

FIG. 1 shows the placement of a battery 100 in a computer system 102 in accordance with an embodiment. Computer system 102 may correspond to a laptop computer, personal digital assistant (PDA), portable media player, mobile phone, digital camera, tablet computer, and/or other portable electronic device. Battery 100 may correspond to a lithium-polymer battery and/or other type of power source for computer system 102. For example, battery 100 may correspond to a lithium-polymer battery that includes one or more cells packaged in flexible pouches. The cells may then be connected in series and/or in parallel and used to power computer system 102.

In one or more embodiments, battery 100 is designed to accommodate the space constraints of computer system 102. For example, battery 100 may include cells of different sizes and thicknesses that are placed side-by-side, top-to-bottom, and/or stacked within computer system 102 to fill up the free space within computer system 102. The use of space within computer system 102 may additionally be optimized by omitting a separate enclosure for battery 100. For example, battery 100 may include non-removable pouches of lithium-polymer cells encased directly within the enclosure for computer system 102. As a result, the cells of battery 100 may be larger than the cells of a comparable removable battery, which in turn may provide increased battery capacity and weight savings over the removable battery.

Those skilled in the art will appreciate that reductions in battery capacity may result from factors such as age, use, defects, heat, and/or damage. Furthermore, a decrease in battery capacity beyond a certain threshold (e.g., below 80% of initial capacity) may be accompanied by swelling of the battery that damages or distorts the portable electronic device.

In particular, charging and discharging of battery 100 may cause a reaction of electrolyte with cathode material, resulting in oxidation of the electrolyte and/or degradation of the cathode material. The reaction may both decrease the capacity of battery 100 and cause swelling through enlargement of the cathode and/or gas buildup inside battery 100. Moreover, exposure to elevated temperatures may cause adhesion polymer layers between the electrodes to reflow, resulting in degradation in the interfaces between the layers of battery 100. The degraded interfaces may increase the thickness of battery 100 and result in lithium plating, which may produce gas and/or result in additional swelling in battery 100.

In one or more embodiments, battery 100 includes a thermally curable composite separator that maintains the integrity of the interfaces between the layers of battery 100, even in the presence of elevated temperatures. As described in further detail below, the composite separator may include a microporous separator, an inorganic filler layer, and an adhesion polymer layer that does not reflow after a thermal treatment is performed to laminate the layers of battery 100 together. The adhesion polymer layer may contain a base polymer and a precursor compound that cures during the thermal treatment. In turn, the cured precursor compound may form a three-dimensional network structure that prevents entangled strands of the base polymer from reflowing during exposure to elevated temperatures. Consequently, the composite separator may minimize swelling in battery 100 and facilitate safe use of battery 100 over the cycle life of battery 100.

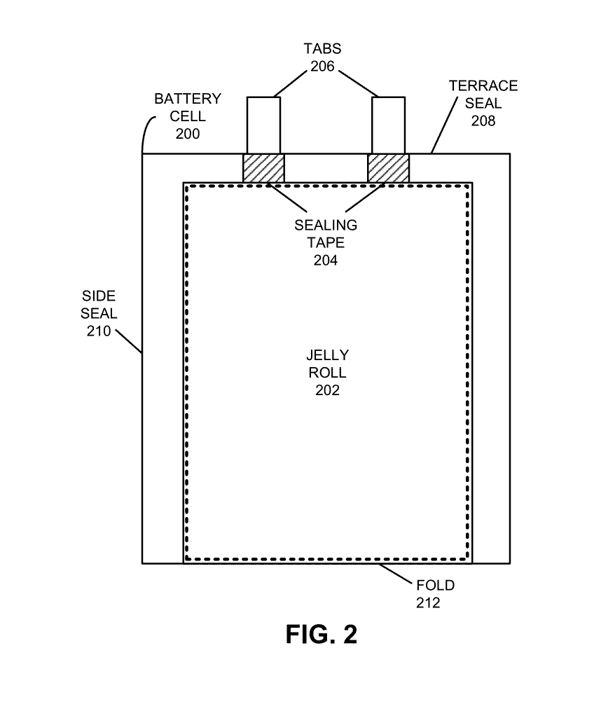

FIG. 2 shows a battery cell 200 in accordance with the disclosed embodiments. Battery cell 200 may correspond to a lithium-ion and/or lithium-polymer cell that is used to power a portable electronic device. Battery cell 200 includes a jelly roll 202 containing a number of layers which are wound together, including a cathode with an active coating, a separator, and an anode with an active coating.

More specifically, jelly roll 202 may include one strip of cathode material (e.g., aluminum foil coated with a lithium compound) and one strip of anode material (e.g., copper foil coated with carbon) separated by one strip of separator material (e.g., conducting polymer electrolyte). As discussed below, the separator may include an adhesion polymer layer that does not reflow after a thermal treatment is performed on the battery cell to laminate the layers together. The cathode, anode, and separator layers may then be wound on a mandrel to form a spirally wound structure. Alternatively, the layers may be used to form other types of battery cell structures, such as bi-cell structures. Jelly rolls are well known in the art and will not be described further.

During assembly of battery cell 200, jelly roll 202 is enclosed in a flexible pouch, which is formed by folding a flexible sheet along a fold line 212. For example, the flexible sheet may be made of aluminum with a polymer film, such as polypropylene and/or polyethylene. After the flexible sheet is folded, the flexible sheet can be sealed, for example, by applying heat along a side seal 210 and along a terrace seal 208.

Jelly roll 202 also includes a set of conductive tabs 206 coupled to the cathode and the anode. Conductive tabs 206 may extend through seals in the pouch (for example, formed using sealing tape 204) to provide terminals for battery cell 200. Conductive tabs 206 may then be used to electrically couple battery cell 200 with one or more other battery cells to form a battery pack. For example, the battery pack may be formed by coupling the battery cells in a series, parallel, or series-and-parallel configuration.

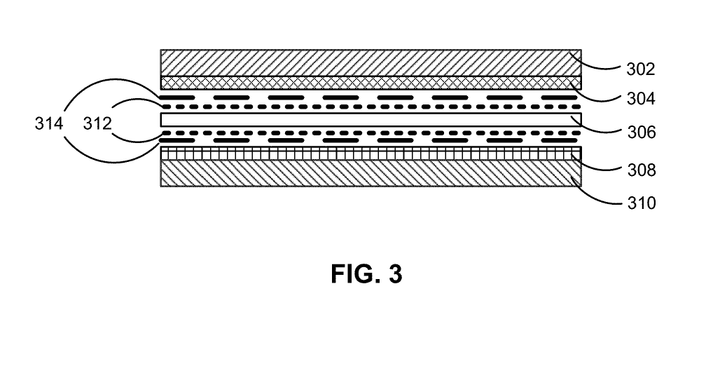

FIG. 3 shows a set of layers for a battery cell (e.g., battery cell 200 of FIG. 2) in accordance with an embodiment. The layers may include a cathode current collector 302, a cathode active coating 304, a microporous separator 306, an anode active coating 308, and an anode current collector 310. Cathode current collector 302 and cathode active coating 304 may form a cathode for the battery cell, and anode current collector 310 and anode active coating 308 may form an anode for the battery cell. The layers may be wound to create a jelly roll for the battery cell, such as jelly roll 202 of FIG. 2. Alternatively, the layers may be used to form other types of battery cell structures, such as bi-cell structures.

As mentioned above, cathode current collector 302 may be aluminum foil, cathode active coating 304 may be a lithium compound, anode current collector 310 may be copper foil, anode active coating 308 may be carbon, and separator 306 may include polypropylene and/or polyethylene. To mitigate swelling and facilitate safe use of the battery cell, additional layers may be disposed between separator 306 and the cathode and anode to form a composite separator for the battery cell.

More specifically, the composite separator may include microporous separator 306, an inorganic filler layer 312, and an adhesion polymer layer 314. Inorganic filler layer 312 may be disposed on both sides of microporous separator 306, and adhesion polymer layer 314 may be disposed over inorganic filler layer 312. Inorganic filler layer 312 and adhesion polymer layer 314 may be applied to one or more surfaces of the composite separator using a solution-coating technique, spray-coating technique, and/or other type of coating technique.

Inorganic filler layer 312 may provide a ceramic coating that promotes temperature stability in the battery cell and mitigates faults caused by mechanical stress, penetration, puncture, and/or electrical shorts. For example, inorganic filler layer 312 may continue to separate the cathode and anode in the event of a localized short (e.g., due to penetration of the layers by a conductive foreign object), which may cause the local temperature to rise above 200° C. and melt the polyolefin material of microporous separator 306.

Adhesion polymer layer 314 may be used to adhere the composite separator to the cathode and anode after a thermal treatment is applied to the layers. During the thermal treatment, pressure and/or temperature may be applied to the layers for a pre-specified period of time. For example, to create a battery cell for a tablet computer, a set of steel plates and a heater may be used to apply a pressure of 900 kilogram-force (kgf) and a temperature of 85° C. for six to eight hours to the layers. The application of pressure and/or temperature to the layers may melt adhesion polymer layer 314 and laminate (e.g., bond) the composite separator to the cathode and anode, thus forming interfaces among the cathode, anode, and composite separator that increase the rigidity of the battery cell and/or the resistance of the battery cell to mechanical stress and/or swelling.

To provide bonding and/or adhesion among the cathode, anode, and separator, adhesion polymer layer 314 may include a base polymer of polyvinylidene fluoride (PVDF), copolymers of PVDF (e.g., poly(vinylidene fluoride-co-hexafluoropropylene) (PVDF-HFP)), acrylonitrile, and/or another binder material. However, exposure of the battery cell to elevated temperatures may melt the binder material and cause adhesion polymer layer 314 to reflow, thereby compromising the integrity of the interfaces. Such elevated temperatures may be caused by use of a portable electronic device powered by the battery cell and/or storage of the portable electronic device and/or battery cell in high-temperature environments (e.g., inside a car that is exposed to the sun).

As mentioned above, adhesion polymer layer 314 may include a precursor compound that prevents reflowing of the binder material after the thermal treatment of the battery cell is performed. The precursor compound may include poly(ethylene oxide) diacrylate, allyl resins, and/or epoxy resins. The precursor compound may be included in adhesion polymer layer 314 in the range of 3-25% by weight. Certain types of precursor compounds, such as poly(ethylene oxide) diacrylate and allyl resins, may also be accompanied by an activator compound such as azoisobutyronitrile in the range of 0.1-0.5% by weight.

Adhesion polymer layer 314 may be formed by mixing one or more base polymers and one or more precursor compounds (with or without an accompanying activator compound) in a homogeneous solution, then applying the solution as a coating on inorganic filler layer 312. The coating may be dried below the activation temperature of the precursor compounds to form the composite separator. After the composite separator is disposed between the cathode and anode to form the battery cell, the thermal treatment may be applied to laminate the layers together. In addition, the thermal treatment may expose the layers to a temperature that is higher than the activation temperature for curing the precursor compound. As a result, the thermal treatment may cause the polymer chains of the precursor compound to cross-link and form a three-dimensional network structure, thus limiting the subsequent movement of entangled base polymer strands and enhancing the mechanical integrity of adhesion polymer layer 314.

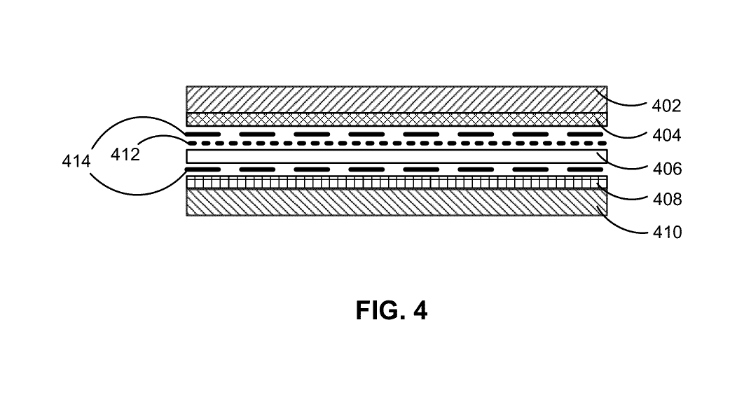

FIG. 4 shows a set of layers for a battery cell (e.g., battery cell 200 of FIG. 2) in accordance with the disclosed embodiments. As with the battery cell of FIG. 3, the layers may include a cathode current collector 402 of aluminum foil, a cathode active coating 404 containing a lithium compound, an anode current collector 410 of copper foil, an anode active coating 408 containing carbon, and a microporous separator 406 of a polyolefin such as polypropylene and/or polyethylene.

The battery cell of FIG. 4 also includes an inorganic filler layer 412 and an adhesion polymer layer 414. Microporous separator 406, inorganic filler layer 412, and adhesion polymer layer 414 may form a composite separator for the battery cell. As mentioned above, inorganic filler layer 412 may include a ceramic coating that promotes temperature stability in the battery cell and mitigates faults caused by mechanical stress, penetration, puncture, and/or electrical shorts. Similarly, adhesion polymer layer 414 may include a base polymer that provides adhesion and/or bonding among the separator, cathode, and anode of the battery cell, as well as a precursor compound that cures during thermal treatment of the battery cell and prevents subsequent reflowing of the base polymer, even in the presence of elevated temperatures. The precursor compound may make up 3-25% of adhesion polymer layer 414 by weight and be accompanied by an activator compound in the range of 0.1-0.5% by weight.

Unlike the battery cell of FIG. 3, inorganic filler layer 412 is disposed on only one side of microporous separator 406. As a result, adhesion polymer layer 414 may be coated over inorganic filler layer 412 on the same side of microporous separator 406 to form a secondary adhesion polymer layer in the battery cell and directly over microporous separator 406 on the other side of microporous separator 406 to form a primary adhesion polymer layer in the battery cell. The primary adhesion polymer layer may be used to laminate the composite separator and cathode of the battery cell, and the secondary adhesion polymer layer may be used to laminate the composite separator and anode of the battery cell.

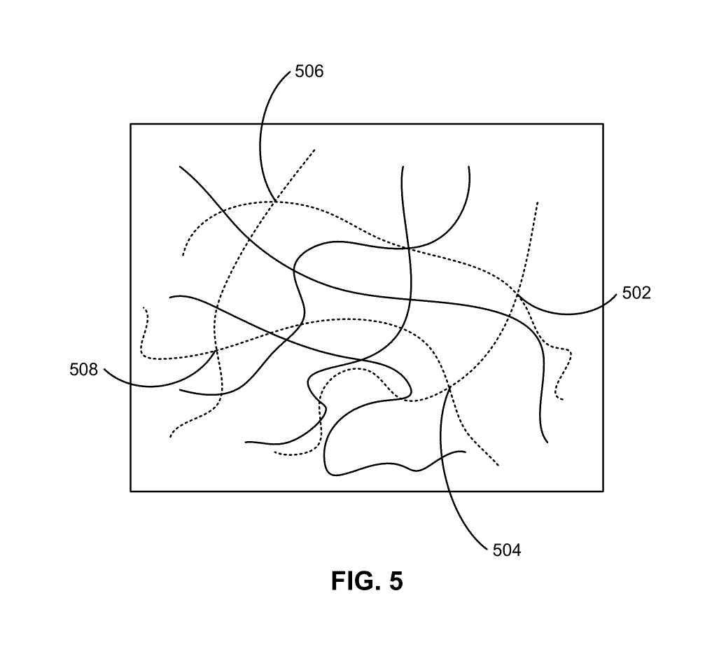

FIG. 5 shows an adhesion polymer layer of a composite separator in a battery cell (e.g., battery cell 200 of FIG. 2) in accordance with the disclosed embodiments. The adhesion polymer layer includes strands of a base polymer, shown in solid lines. The adhesion polymer layer also includes strands of a precursor compound, shown in dashed lines. The base polymer may include PVDF, copolymers of PVDF, polyacrylonitrile, and/or other binder materials. The precursor compound may include poly(ethylene oxide) diacrylate, allyl resins, and/or epoxy resins. The poly(ethylene) oxide diacrylate and/or allyl resins may also be accompanied by an activator compound such as azoisobutyronitrile. For example, the precursor compound may make up the adhesion polymer layer in the range of 3-25% by weight, and any accompanying activator compound may make up the adhesion polymer layer in the range of 0.1-0.5% by weight.

The adhesion polymer layer may be created by mixing (e.g., through stifling and/or agitation) the base polymer with the precursor compound in a solvent to form a homogeneous solution. During creation of the homogeneous solution, degassing and/or de-aeration of the solution may be performed. The solution may then be coated onto a microporous separator and/or an inorganic filler layer disposed over the microporous separator and dried below the activation temperature of the precursor compound to form the composite separator.

The composite separator may then be disposed between a cathode layer and anode layer for the battery cell, and a thermal treatment may be performed to laminate the layers together. During the thermal treatment, pressure and/or temperature may be applied to the layers to form a jelly roll, bi-cell structure, and/or other type of battery structure. The temperature may melt the base polymer and bond the composite separator to the other layers.

The temperature of the thermal treatment may also be higher than the activation temperature of the precursor compound, thereby triggering the curing reaction of the precursor compound and forming a number of cross-linked points 502-508 in the precursor compound. In turn, cross-linked points 502-508 may form a three-dimensional network structure that limits the movement of entangled base polymer strands, thus maintaining the bond between the composite separator and the other layers even in the presence of elevated temperatures.

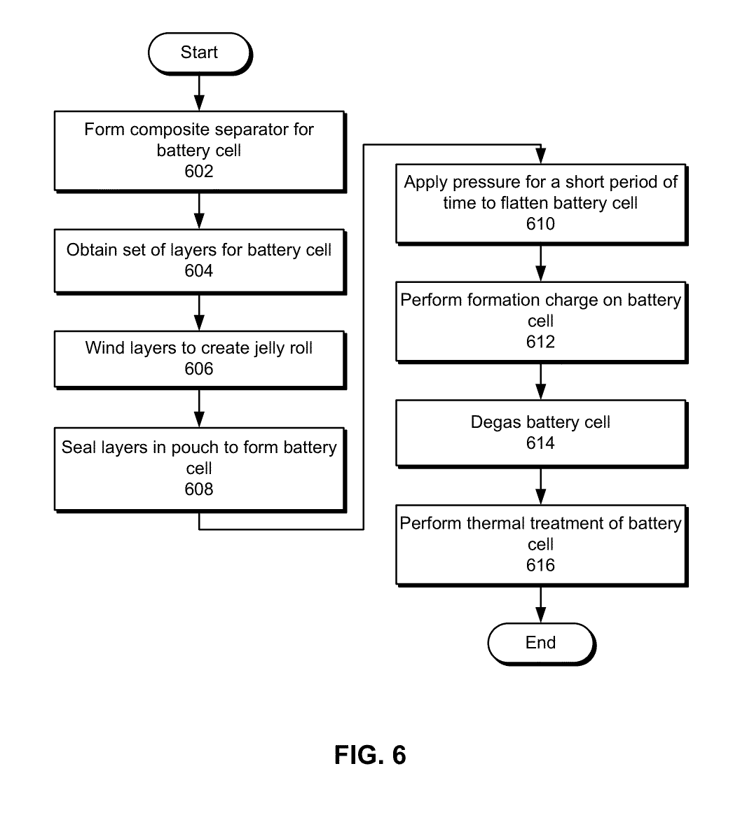

FIG. 6 shows a flowchart illustrating the process of manufacturing a battery cell in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

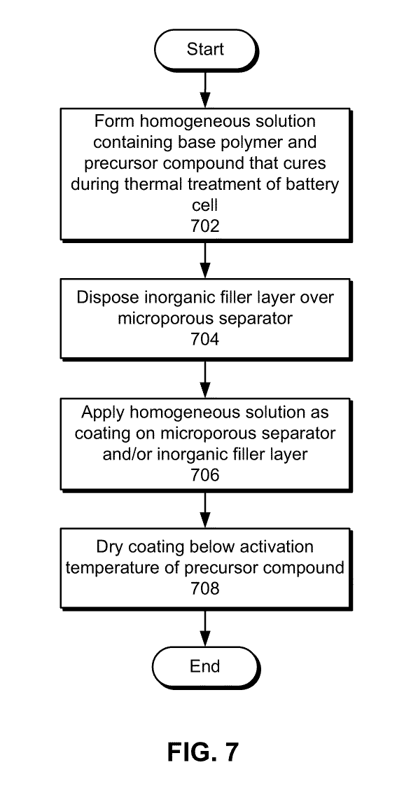

First, a composite separator for the battery cell is formed (operation 602). The composite separator may include an adhesion polymer layer that does not reflow after a thermal treatment of the battery cell is performed. Creation of composite separator for battery cells is described in further detail below with respect to FIG. 7.

Next, a set of layers for the battery cell is obtained (operation 604). The layers may include a cathode with an active coating, the composite separator, and an anode with an active coating. The layers are wound to create a jelly roll (operation 606). The winding step may be skipped and/or altered if the layers are used to create other battery cell structures, such as bi-cells. The layers are then sealed in a pouch to form the battery cell (operation 608). For example, the battery cell may be formed by placing the layers into the pouch, filling the pouch with electrolyte, and forming side and terrace seals along the edges of the pouch. The battery cell may then be left alone for 1-1.5 days to allow the electrolyte to distribute within the battery cell.

After the layers are sealed in the pouch, pressure is applied for a short period of time to flatten the battery cell (operation 610), and a formation charge is performed on the battery cell (operation 612). For example, the pressure may be applied for about a minute using a set of steel plates on either side of the battery cell. The formation charge may then be performed at one or more charge rates until the battery's voltage reaches a pre-specified amount.

The battery cell is then degassed (operation 614). To degas the battery cell, a portion of the pouch that does not contact the layers is punctured to release gas generated during the formation charge by the battery cell. Next, the pouch is resealed along a line that is closer to the layers than the punctured portion. Finally, extra pouch material associated with the punctured portion is removed from the battery cell.

Finally, a thermal treatment of the battery cell is performed (operation 616). During the thermal treatment, pressure (e.g., 0.13 kgf per square millimeter) and/or temperature (e.g., about 85° C.) may be applied to the layers. The pressure and/or temperature may melt a base polymer in the adhesion polymer layer, causing the adhesion polymer layer to laminate and/or bond the layers of the battery cell together and creating a solid, compressed structure instead of a set of loosely stacked, unbonded layers. The pressure and/or temperature may also cause a precursor compound in the adhesion polymer layer to cure, thus preventing subsequent reflowing of the base polymer and maintaining the integrity of the bonds between the layers, even during exposure to elevated temperatures.

FIG. 7 shows a flowchart illustrating the process of manufacturing a composite separator for a battery cell in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, a homogeneous solution containing a base polymer and a precursor compound that cures during thermal treatment of the battery cell is formed (operation 702). The homogeneous solution may be created by stirring, agitating, and/or otherwise mixing the base polymer and precursor compound in a solvent, then degassing and/or de-aerating the mixture. The homogeneous solution may also include an activator compound for the precursor compound. For example, the homogeneous solution may include the precursor compound in the range of 3-25% by weight and the activator compound in the range of 0.1-0.5% by weight.

Next, an inorganic filler layer is disposed over a microporous separator (operation 704). The inorganic filler layer may include a ceramic coating that promotes temperature stability in the battery cell and mitigates faults caused by mechanical stress, penetration, puncture, and/or electrical shorts. The homogeneous solution is then applied as a coating on the microporous separator and/or inorganic filler layer (operation 706). For example, the inorganic filler layer may be disposed over one side of the microporous separator, and the homogeneous solution may be coated over the inorganic filler layer on that side and directly on the microporous separator on the other side of the microporous separator. Alternatively, the inorganic filler layer may be coated on both sides of the microporous separator, and the homogeneous solution may be coated over the inorganic filler layer instead of the microporous separator.

Finally, the coating is dried below an activation temperature of the precursor compound (operation 708). For example, the coating may be dried at a temperature that is below the 85-130° C. required to trigger curing of the precursor compound.

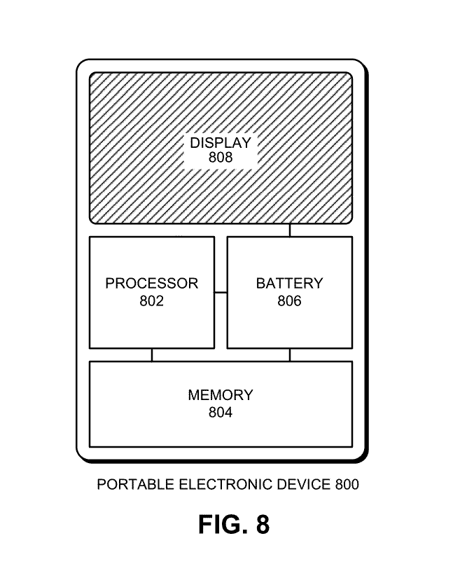

The above-described rechargeable battery cell can generally be used in any type of electronic device. For example, FIG. 8 illustrates a portable electronic device 800 which includes a processor 802, a memory 804 and a display 808, which are all powered by a battery 806. Portable electronic device 800 may correspond to a laptop computer, mobile phone, PDA, tablet computer, portable media player, digital camera, and/or other type of battery-powered electronic device. Battery 806 may correspond to a battery pack that includes one or more battery cells. Each battery cell may include a set of layers sealed in a pouch, including a cathode, a composite separator, and an anode. The composite separator may include an adhesion polymer layer that does not reflow after a thermal treatment of the battery cell is performed to laminate the layers together. The composite separator may also include a microporous separator and an inorganic filler layer disposed between the microporous separator layer and the adhesion polymer layer.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A battery cell, comprising:
a set of layers, comprising:
a cathode with an active coating;
an anode with an active coating; and
a composite separator comprising an adhesion polymer layer that does not reflow after a thermal treatment of the battery cell is performed to laminate the layers together; and
a pouch enclosing the layers, wherein the pouch is flexible.

2. The battery cell of claim 1, wherein the composite separator further comprises:
a microporous separator; and
an inorganic filler layer disposed between the microporous separator layer and the adhesion polymer layer.

3. The battery cell of claim 2, wherein the inorganic filler layer comprises a ceramic coating.

4. The battery cell of claim 2, wherein the inorganic filler layer is disposed on one or both sides of the microporous separator.

5. The battery cell of claim 1, wherein the adhesion polymer layer comprises:
a base polymer; and
a precursor compound that cures during the thermal treatment of the battery cell.

6. The battery cell of claim 5, wherein the adhesion polymer layer comprises the precursor compound in the range of 3-25% by weight.

7. The battery cell of claim 5, wherein the adhesion polymer layer further comprises:
an activator compound for the precursor compound.

8. The battery cell of claim 7, wherein the adhesion polymer layer comprises the activator compound in the range of 0.1-0.5% by weight.

9. The battery cell of claim 1, wherein the layers are wound to create a jelly roll or stacked prior to sealing the layers in the pouch.

10. A method for manufacturing a battery cell, comprising:
obtaining a set of layers for the battery cell, wherein the set of layers comprises:
a cathode with an active coating;
an anode with an active coating; and
a composite separator comprising an adhesion polymer layer that does not reflow after a thermal treatment of the battery cell is performed;
sealing the layers in a pouch to form the battery cell, wherein the pouch is flexible; and
performing the thermal treatment of the battery cell to laminate the layers together using the adhesion polymer layer.

11. The method of claim 10, further comprising:
forming the composite separator by:
disposing an inorganic filler layer comprising a ceramic coating over a microporous separator; and
disposing the adhesion polymer layer over the inorganic filler layer.

12. The method of claim 11, wherein the inorganic filler layer is disposed on one or both sides of the microporous separator.

13. The method of claim 10, wherein the adhesion polymer layer comprises:
a base polymer; and
a precursor compound that cures during the thermal treatment of the battery cell, wherein the adhesion polymer layer comprises the precursor compound in the range of 3-25% by weight.

14. The method of claim 13, wherein the adhesion polymer layer further comprises:
an activator compound for the precursor compound.

15. The method of claim 13, wherein the adhesion polymer layer comprises the activator compound in the range of 0.1-0.5% by weight.

16. A portable electronic device, comprising:
a set of components powered by a battery pack; and
the battery pack, comprising:
a battery cell, comprising:
a set of layers, comprising:
a cathode with an active coating;
an anode with an active coating; and
a composite separator comprising an adhesion polymer layer that does not reflow after a thermal treatment of the battery cell is performed to laminate the layers together; and
a pouch enclosing the layers, wherein the pouch is flexible.

17. The portable electronic device of claim 16, wherein the composite separator further comprises:
a microporous separator; and
an inorganic filler layer disposed between the microporous separator layer and the adhesion polymer layer.

18. The portable electronic device of claim 16, wherein the adhesion polymer layer comprises:
a base polymer; and
a precursor compound that cures during the thermal treatment of the battery cell.

19. The portable electronic device of claim 18, wherein the adhesion polymer layer comprises the precursor compound in the range of 3-25% by weight.

20. The portable electronic device of claim 18, wherein the adhesion polymer layer further comprises:
an activator compound for the precursor compound, wherein the adhesion polymer layer comprises the activator compound in the range of 0.1-0.5% by weight.

21. A method for manufacturing a composite separator for a battery cell, comprising:
forming a homogeneous solution comprising a base polymer and a precursor compound that cures during thermal treatment of the battery cell; and
applying the homogeneous solution as a coating on a microporous separator.

22. The method of claim 21, further comprising:
disposing an inorganic filler layer over the microporous separator prior to applying the homogeneous solution as the coating.

23. The method of claim 21, wherein the homogeneous solution further comprises an activator compound for the precursor compound.
